(19) United States
(12) Patent Application Publication
(10) Pub. No.: US 2024/0412326 A1
(43) Pub. Date: Dec. 12, 2024

(54) SYSTEMS AND METHODS FOR PATCHROT - A TECHNIQUE FOR TRAINING VISION TRANSFORMERS

(71) Applicants: Baoxin Li, Chandler, AZ (US); Sachin Chhabra, Tempe, AZ (US)

(72) Inventors: Baoxin Li, Chandler, AZ (US); Sachin Chhabra, Tempe, AZ (US)

(73) Assignee: Arizona Board of Regents on Behalf of Arizona State University, Tempe, AZ (US)

(21) Appl. No.: 18/738,963

(22) Filed: Jun. 10, 2024

Related U.S. Application Data
(60) Provisional application No. 63/507,358, filed on Jun. 9, 2023.

(51) Int. Cl. G06T 3/60; G06T 7/10

(52) U.S. Cl. CPC G06T 3/60; G06T 7/10; G06T 2207/20021; G06T 2207/20081; G06T 2207/20084

(57) ABSTRACT

Examples of computer-implemented training techniques are described and tailor-made for Vision Transformers (ViTs). Example techniques include training a model (network) for the rotation of images and image patches and training of the model to predict the rotation angles. The model learns to extract both global and local features from an image.

### CROSS REFERENCE TO RELATED APPLICATIONS

This is a non-provisional application that claims benefit to U.S. Provisional Application Ser. No. 63/507,358 filed on Jun. 9, 2023, which is herein incorporated by reference in its entirety.

### GOVERNMENT SUPPORT

This invention was made with government support under Grant No. N00014-19-1-2119 awarded by the Office of Naval Research. The Government has certain rights in the invention.

### FIELD

The present disclosure generally relates to machine learning and training technologies; and more particularly to a self-supervised technique for vision transformers to predict rotation angles of images and image patch.

### BACKGROUND

In the past decade, convolution neural networks (ConvNets) have made tremendous progress in various image processing fields like object recognition (Szegedy et al. [2015], He et al. [2016]), segmentation (Ronneberger et al. [2015]), etc. This progress is primarily a result of supervised training on labeled data. The features learned by such a network are highly transferable and can be used for similar tasks (Pan and Yang [2009], Chhabra et al. [2021], Wang and Deng) [2018]). However, labeling a dataset is generally expensive and time-consuming.

Self-supervised learning alleviates this problem by learning rich features without the need for manual annotation of labeling the dataset. Hence, training a network in an unsupervised way is gaining a lot of traction. Self-supervised learning techniques train a network by creating an auxiliary task that requires an understanding of the object. (Noroozi and Favaro [2016]) divided an image into patches and trained the network to solve a jigsaw puzzle of the shuffled patches. Another technique predicts the angle of a rotated image (Gidaris et al. [2018]).

Existing self-supervised techniques were designed to train ConvNets. However, in recent years, Vision Transformers (ViT) have surpassed ConvNets (Dosovitskiy et al. [2020]). Transformers were initially designed for Natural Language Processing (Vaswani et al. [2017]) but now are being applied to other modalities like speech (Li et al. [2019]), image (Dosovitskiy et al. [2020]), video (Arnab et al. [2021]) etc. Nevertheless, ViTs are considered data-hungry models as they outperform ConvNets only when huge labeled training data is available. When the amount of training data available is limited, their performance is not as good as ConvNets. This is primarily because they lack the inductive bias of ConvNets like translation equivariance and locality (Dosovitskiy et al. [2020]). This elevates the importance of unsupervised training of ViTs. Existing self-supervised techniques can be applied to ViTs. However, ViTs process images differently than ConvNets. ConvNets process the image like a grid and learn shared kernels to extract features whereas ViTs divide the images into patches and apply self-attention to the embedding of the patches.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is an illustration of a model diagram of the approach described herein. The input image is split into patches. The image and the patches are rotated by a random angle of 90° resulting in rotation by 0°, 90°, 180°, or 270°. The vision transformer (ViT) is trained to predict the rotation angle for the image and each patch using new additional MLP heads. Dotted lines denote the weights are shared. Best viewed in Color.

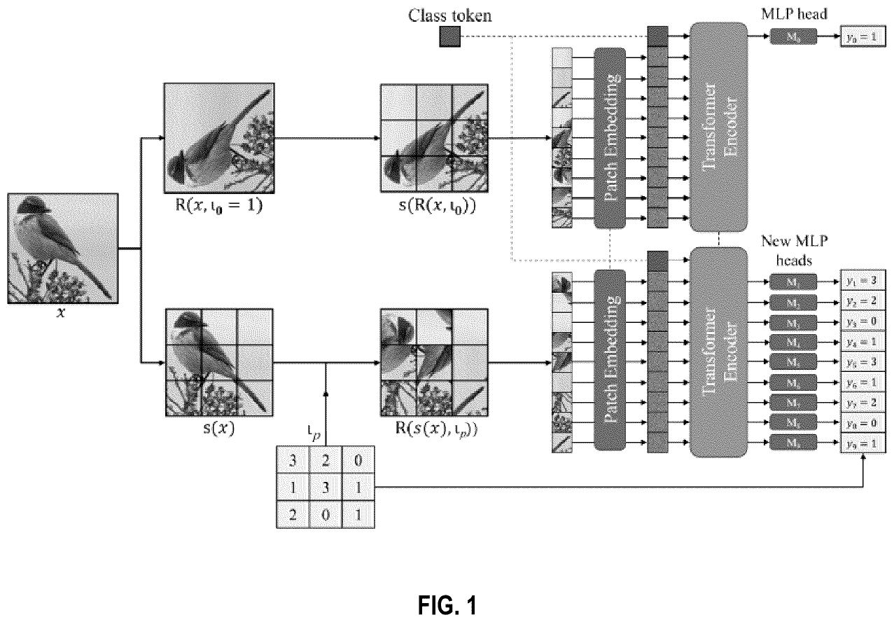

FIG. 2 is one or more graphs showing classification accuracies for (a) CIFAR-10, (b) CIFAR-100, (c) FashionMNIST and (d) Tiny-ImageNet datasets for Supervised, RotNet (Gidaris et al. [2018]) and PatchRot. Solid lines denote Top-1 accuracy and the dashed lines denote Top-5 accuracy on the Y-axis. The X-axis contains different layers of the transformer. While finetuning on the downstream task all the layers before that layer are frozen. NF: No layers are frozen; PE: Patch Embedding block; EB-1 to EB-7 are the encoder blocks of the Vision Transformer. MLP: The whole network is frozen except for the new output linear layer.

FIG. 3 illustrates sample Attention Maps of ViT trained using PatchRot on the validation set of Tiny-ImageNet. Upper row: Input and Lower row: Attention Map.

FIG. 4 illustrates one or more graphs with top-5 classification accuracy vs Pretraining epochs for CIFAR-100. Supervised denotes the supervised accuracy; Patch Rot denotes the PatchRot self-supervised accuracy on testset; NF, EB5 and MLP denotes the accuracy on finetuning all the layers, freezing layers till EB5 and no fine-tuning of the network respectively. Best viewed in color.

FIG. 5 shows one or more graphs of PatchRot performance in a transfer learning setting. PatchRot denotes the ViT was trained on the source dataset self-supervised using PatchRot. Supervised denotes the ViT was trained on source using the supervised object classification task. Solid lines and the dashed lines show the Top-1 and Top-5 accuracy on the Y-axis respectively. The X-axis contains different layers of the transformer and while finetuning on the target dataset all the layers before that layer are frozen.

FIG. 6 shows one or more graphs of top-1 classification accuracies for Rotation Invariant datasets: (a) SVHN and (b) MNIST for Supervised, RotNet (Gidaris et al. [2018]) and PatchRot. Solid lines denote Top-1 accuracy and the dashed lines denote Top-5 accuracy on the Y-axis. The X-axis contains different layers of the transformer. While finetuning on the downstream task all the layers before that layer are frozen.

FIG. 7 is a Sample Attention Maps of ViT trained using PatchRot on validation set of Tiny-ImageNet. Odd row: Input and Even row: Attention Map.

FIG. 8 is a simplified illustration of an example system/framework for implementing the inventive concepts described herein.

FIG. 9 is a simplified illustration of a computing device that may be implemented with or as part of example systems described herein.

Corresponding reference characters indicate corresponding elements among the view of the drawings. The headings used in the figures do not limit the scope of the claims.

### DETAILED DESCRIPTION

The present disclosure relates to examples of a system and associated methods for training vision transformers to predict rotation angles of images and image patch (“PatchRot”). Vision transformers require a huge amount of labeled data to outperform convolutional neural networks. However, labeling a huge dataset is a very expensive process. Self-supervised learning techniques alleviate this problem by learning features similar to supervised learning in an unsupervised way. In this paper, we propose a self-supervised technique PatchRot that is crafted for vision transformers. PatchRot rotates images and image patches and trains the network to predict the rotation angles. The network learns to extract both global and local features from an image. Our extensive experiments on different datasets showcase PatchRot training learns rich features which outperform supervised learning and compared baseline.

### Introduction

PatchRot is a self-supervised technique for ViTs. PatchRot trains a ViT to predict the rotation of patches as well as that of the image. Given an image, we either rotate the image or its patches at a time. The classification head of the ViTs contains the global information of the image and the patch heads contain the local information. The classification head is used to predict the rotation angle of the image and the other heads are used to predict the rotation angle for their respective patches. This way, PatchRot learns to extract both global and local features. PatchRot is a simple self-supervised technique crafted for ViTs. It trains the classification head as well as the patch heads. Our experiments on different datasets showcase the strength of PatchRot over supervised training and compared baselines.

### Self-Supervised Learning

Self-supervised learning methods aim to learn rich features in an unsupervised way that can be directly used in other tasks (downstream tasks) such as image classification, object detection, image segmentation, etc. These techniques generally design a surrogate task that can generate training supervision without manual annotation and solving them would require an understanding of the object. (Zhang et al. [2016]) proposed to train a ConvNet to colorize a grayscale image. (Pathak et al. [2016]) trained a network to fill the missing parts of an image. (Doersch et al. [2015]) trained the network to predict the relative position of a patch given another patch from the same image. (Noroozi and Favaro [2016]) extracted nine patches from an image and trained the network to solve the jigsaw puzzle of the shuffled patches. (Gidaris et al. [2018]) proposed a pretext task of predicting the angle of 2D rotation (0°, 90°, 180°, 270°) applied to an input image to generate features that are supervised through this task. Dosovitskiy et al. [2016] proposed a training scheme to learn features by trying to predict the classes of samples generated by a set of transformations.

### Vision Transformers

In 2020, (Dosovitskiy et al. [2020]) introduced a new class of image-processing networks—Vision Transformers (ViT) that operates solely on the attention mechanism. Next, we discuss the different components of a ViT—Image Tokenization, Patch Embedding block, Encoder block, and MLP head.

Image Tokenization: ViT splits the 2-dimensional image using into 16′16 non-overlapping image patches in top-left to bottom right order. This forms a 1-dimensional sequential input of image patches which are then used as the input.

Patch Embeddings: A fully connected layer is used to convert each image token into an embedding vector. Splitting the image into 1-D image patches destroys the spatial relationships between the patches. Hence, a learnable spatial embedding is added to the embedding of patches to provide spatial information. Similar to BERT (Devlin et al. [2018]), a learnable class token is added to the start of the patch embedding sequence and is used for image classification later.

Transformer Encoder: An encoder block consists of a multi-headed self-attention block and a forward expansion block. Self-attention block computes attention between the input tokens and the forward expansion block utilizes multiple fully-connected layers to transform the input. Both the blocks use a normalization layer before processing the input. A residual connections are used between input, self-attention block output and the forward expansion block.

MLP Head: At the last encoder block, the output of the class token (added in patch embedding block) is used and the rest of the outputs are ignored. The class token output is processed through a multi-layer perception classifier (also known as MLP head) which classifies the image into one of the categories.

### Methodology

### Problem Definition

Let x∈[0,1]^{C×H×W} be the input image, where C, H, W represent the number of channels, the height, and the width of the image, respectively. The goal is to train a ViT T_{ϕ} with parameters ϕ in an unsupervised manner and extract high-quality features. As input to the ViT, we preprocess the image into a sequence of image patches

$$s ( x ) = [ {x}_{1}^{s} , {x}_{2}^{s} , … , {x}_{N}^{s} ] ,$$

where N is the number of patches. The image patch dimensions are determined by patch size P where xᵢ^{s}∈[0,1]^{C×P×P} represents the i-th patch of image x and

$$N = \frac{H}{P} \cdot \frac{W}{P} .$$

The image height H and width W is a multiple of patch size P to ensure that N is an integer.

### Patch Rot

PatchRot is a technique to train a ViT where the rotation angle of an image and the rotation angle of individual patches of an image are predicted. RotNet (Gidaris et al. [2018]) showcased that a ConvNet trained to predict the rotation of an image learns features as good as those learned using supervised training. We train a ViT where the classification head (generally used for predicting the object category) is used to predict the rotation angle of the image. We use the last encoder output of the other heads to predict the rotation angles for the individual patches using new multilayer perceptron (MLP) heads. This way the ViT can produce an output for every element in the input sequence whereas ConvNets are limited to just one output. Therefore, PatchRot applies only to ViTs.

We represent the rotation operation as R (; ι), where ι∈{0,1,2,3} that rotates the input by θ=90°. ι resulting in rotation of 0°, 90°, 180°, or 270°. A rotated image xᵣ=R (x;ι₀) uses y=ι as its the label for training. Similar to (Gidaris et al. [2018]), we found that training using all 4 angles of rotations in the same minibatch yielded the best results. We overload the rotation operator to represent the PatchRot version of the image xₚᵣ=R(s(x);ιₚ), where we rotate all of N patches of the input image. ιₚ={ι₁,ι₂. . . ,ι_{N}} denotes the sequence of rotation applied to the corresponding input sequence s(x) and each ιᵢ∀i=1,2, . . . ,N is sampled randomly using a discrete uniform distribution.

We train the ViT T₉₉ using xᵣ and xₚᵣ images. The ViT T_{ϕ}=PE⊙EB⊙M consists of a patch encoding block PE followed by encoder blocks EBᵢ where i∈{1,2, . . . ,e} and e is the total number of encoder blocks, and an MLP head M for classification. Let E(s(x))={E₀(s(x)),E₁(s(x)), . . . ,E_{N}(s(x))} denote the output at the last encoder block EBₑ where Eᵢ(s(x))∈ [symbol] ^{h} is the i-th output corresponding to the input sequence s(x) and h is the embedding size. E₀(s(x)) represents the encoding of the classification head and {E₁(s(x)), . . . , E_{N}(s(x))} are the encoding for the patch heads. In the case of image rotation xᵣ, the encoding from the classification head is passed to the MLP head M₀ to predict the rotation category of the image as M₀ (E₀(s(xᵣ))). The encodings of the patch heads in this case are ignored. In the case of patch rotation, we introduce new MLPs M₁, M₂, . . . , M_{N} to classify the encodings of the individual patches. The rotation angles of the individual patches are predicted by the MLPs as Mᵢ(Eᵢ(s(xₚᵣ)))∀i=1,2, . . . ,N. PatchRot trains the ViT using,

$${\sum }_{j = 0}^{3} {ℒ}_{c e} ( {M}_{0} ( {E}_{0} ( s ( R ( x , j ) ) ) ) , y = j ) + {\sum }_{i = 1}^{N} {ℒ}_{c e} ( {M}_{i} ( {E}_{i} ( R ( s ( x ) , {l}_{p} ) ) ) , y = {θ}_{i} ) , \qquad ( 1 )$$

where the first term is the loss function penalizing rotation misclassification for each of the 4 angles of image rotation and the second term is the loss function penalizing rotation misclassification for the image patches. [symbol] _{ce} is the standard cross-entropy loss function. Note that we do not rotate the image when rotating image patches as doing both simultaneously have demonstrated to hurt the downstream task performance.

### Training Procedure

To avoid the possibility of the network learning to predict the angle of patch rotations using edge continuity, we use a buffer gap B between the patches, i.e., we initially partition the image using a larger patch size P′=P+B, where P′>P. Then from each such patch, we randomly crop a P sized patch. This results in a gap between patches of random size between 0 to 2B pixels. Due to the buffer between patches, the input size is reduced. Instead of scaling the image/patches to adjust to the original input size, we found it beneficial to perform the self-supervised training on reduced image size and use the original size for transferring knowledge to downstream tasks. To be precise, the PatchRot training image xₚᵣ size is C×Hₚᵣ×Wₚᵣ where

$${H}_{p r} = P \cdot [ \frac{H}{P + B} ] , and {W}_{p r} = P \cdot [ \frac{W}{P + B} ] ,$$

and [symbol] denotes the floor operation. The number of patches is given by

$${N}_{p r} = [ \frac{H}{P + B} ] \cdot [ \frac{W}{P + B} ] .$$

For creating a rotated image xᵣ, we produce a crop of this size instead of the original size for our algorithm and then rotate the cropped image. We were guided by the fact that training on smaller resolution images and then fine-tuning with higher resolution images has shown to yield performance gains (Touvron et al. [2019]).

Once the network is trained using PatchRot, we remove the newly added MLP heads—M₁, M₂, . . . , M_{N} and only use the classification head's encoder output and its MLP head (just like the original ViT) for downstream tasks. For adapting the network to the new classification task, we replace the last classification layer from MLP head M₀ with a new layer having an output size equal to the number of categories in the new task before retraining the network. PatchRot training is performed at a smaller input size but for the downstream task, we use the original image size. The larger image size results in an increase in the number of input patches:

$$[ \frac{H}{P + B} ] \cdot [ \frac{W}{P + B} ] \to \frac{H}{P} \cdot \frac{H}{P} .$$

Hence, we apply a linear interpolation of the positional embedding as designed in the original ViT (Dosovitskiy et al. [2020]) for this case.

### Experiments

### Datasets

We test our approach on datasets like CIFAR-10, CIFAR-100, FashionMNIST, and Tiny-ImageNet datasets using a scaled-down version of the ViT (described in section 4.2) due to hardware limitations. We use 32′32 image size for CIFAR-10, CIFAR-100 and FashionMNIST datasets and 64′64 for Tiny-ImageNet. Random crop with zero padding of size 4 and a random horizontal flip is used as augmentations for CIFAR-10, CIFAR-100, and Tiny-ImageNet datasets. We did not apply any augmentations for FashionMNIST. Also, we do not use any padding while creating patch rotation image xₚᵣ as padding pixels tend to work as a shortcut to find the rotation angle.

### Training Details

The experiments are performed using ViT-Lite from (Hassani et al. [2021]) (scaled-down version of the original ViT architecture (Dosovitskiy et al. [2020]) which is designed for smaller datasets. Specifically, the number of encoder blocks is reduced to 6 with 256 embedding size and 512 expansion size. The number of attention heads is also reduced to 4 and the dropout is set to 0.1. We train the network with the patch size of P=4 for CIFAR-10, CIFAR-100, and FashionMNIST and P=8 for TinyImageNet. The buffer B is set to ¼ of the patch size which results in PatchRot input size of 24×24 for 32×32 images and 48×48 for 64×64 images.

We used Adam Optimizer for training the ViT with a learning rate and a weight decay of 5×10⁻⁴ and 3×10⁻² respectively. The learning rate is warmed up for the first 10 epochs and then decayed using a cosine schedule. The batch size is set to 128. However, due to multiple variations of the same image being presented in a mini-batch, the effective batch size for PatchRot is 128×5 samples.

TABLE 1
Ablation study of our method on CIFAR-10.

| Initalization | NF | PE | EB1 | EB2 | BB3 | EB4 | EBS | EB6 | EB7 | MLP |
|---|---|---|---|---|---|---|---|---|---|---|
| No ImageRot | 91.8 | 91.9 | 91.9 | 91.4 | 91.0 | 90.0 | 88.8 | 82.2 | 69.4 | 54.9 |
| No PatchRot | 91.0 | 91.2 | 90.7 | 90.2 | 89.4 | 88.6 | 87.8 | 85.3 | 80.1 | 70.8 |
| Original Size | 92.1 | 92.2 | 91.6 | 91.1 | 90.7 | 89.9 | 89.0 | 86.2 | 81.6 | 73.9 |
| Rotate Ing & Patch | 90.7 | 90.7 | 90.8 | 90.6 | 90.6 | 90.2 | 88.3 | 82.5 | 72.8 | 58.4 |
| Reuse MLP head | 91.1 | 91.0 | 90.9 | 90.4 | 89.9 | 89.6 | 87.7 | 84.0 | 76.6 | 65.7 |
| PatchRot-full | 92.6 | 92.5 | 92.3 | 92.4 | 91.8 | 91.1 | 90.0 | 87.0 | 83.2 | 75.8 |

Columns denote the parts of the ViT being fine-tuned and all the layers before that layer are frozen. NF: No layers are frozen; PE: Patch Embedding block; EB-1 to EB-7 are the encoder blocks of the Vision Transformer. MLP: The whole network is frozen except for the new output linear layer.

We follow the procedure of fine-tuning the layers after the self-supervision training as also implemented by (Noroozi and Favaro [2016]) for the experiments. The self-supervised training is performed for 300 epochs and the supervised training is performed for 200 epochs. We provide additional experimental results with different input patch sizes in the Appendix.

### Results

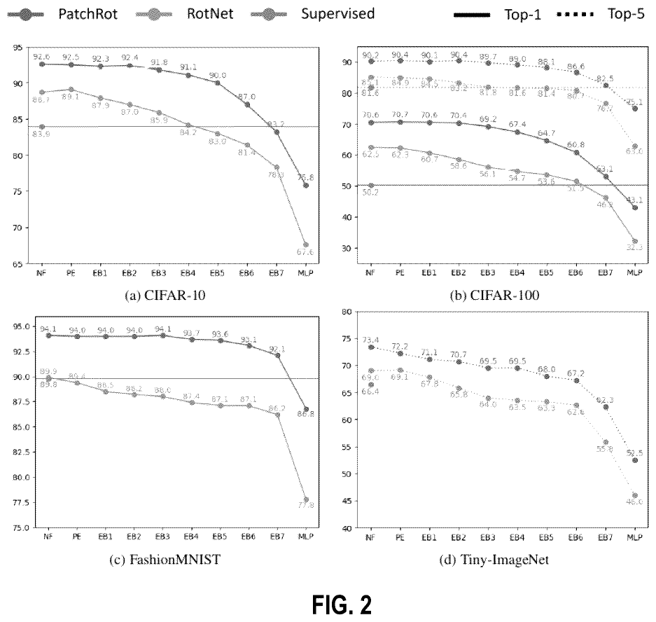

We compare our approach with supervised learning and image rotation prediction (Gidaris et al. [2018]). RotNet is a convolutional neural network approach. We used the code from their official repo and used it to train the ViT with the same setting as PatchRot. The results are in FIG. 2, and the tabular versions are available in the appendix. In FIG. 2, NF denotes when no layers are frozen and the whole network was trained. MLP denotes linear probing of the learned features where we freeze the whole network and only train the last classification layer. The middle results denote results on fine-tuning specific encoder blocks. Fine-tuning just the MLP head (one fully connected layer) achieves results close to the supervised learning and fine-tuning one encoder block and MLP head outperforms the supervised training from scratch.

### Analysis

### Ablation Study

In this section, we test the importance of different components of PatchRot using CIFAR-10 and present the results in Table 1. First, we train the ViT on the patch rotation image xₚᵣ only and exclude the image rotation xᵣ versions (No ImageRot). As we do not train the classification head, the network learns only the local characteristics and as we freeze more layers, we can notice the drop in performance, signifying the importance of global context. Similarly, in the second experiment, we exclude the xₚᵣ (No PatchRot). This is comparable to the RotNet which is trained to predict image rotation using a convolutional network with the only difference that the self-supervised training is performed at a reduced image size. Next, we test the significance of reduced size training by comparing it with self-supervised training on the original image scale (Original Size). To test this, we divide the image using the original patch size P and we randomly crop P-B sized patches from it. These cropped patches are then resized to patch size P to maintain the original image size and still have a buffer. We also test our hypothesis of rotating images and patches together (Section 3.2) in our next experiment (Rotate Img & Patch). Last, we experiment with the newly added MLP heads (Reuse MLP Head). Since adding new MLP heads temporarily increases the model size. Instead of adding new MLP heads, we use the same original MLP head for predicting the rotation angle for the image and the patches.

### Attention Maps

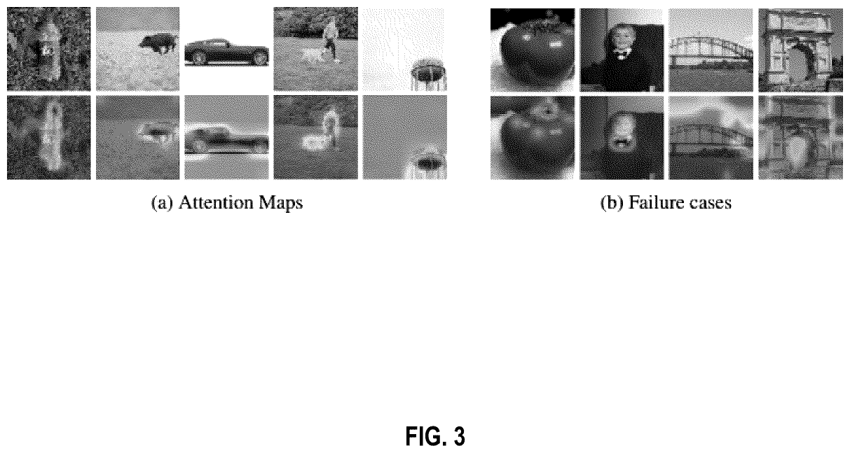

We show the attention maps on the validation set of Tiny-ImageNet for ViT trained using PatchRot in FIG. 3. With just the unsupervised training, the model learns to attend to the main object in the image. We also show failure cases in FIG. 3(B) where the model learns to solve the problem by attending to a part of the object like the top green part of the tomato or using a background feature like sky positioning. More attention maps are available in the Appendix.

### Pre-Training Epochs V. Classification Accuracy

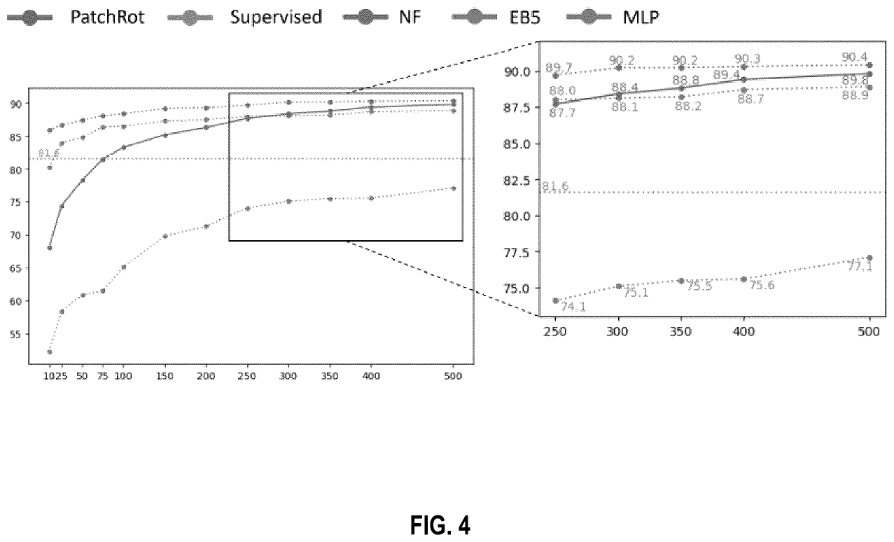

Here, we study the impact of PatchRot's pretraining on the final classification performance. We train the ViT using our approach with a different number of epochs {10, 25, 50, 75, 100, 150, 200, 250, 300, 350, and 400}, for the CIFAR-100 dataset. The results are in FIG. 4. Pretraining with just a few epochs with PatchRot we can observe significant improvement in final performance compared to training from scratch (Supervised). Also, PatchRot did not show any signs of overfitting, and training it longer (350, 400, and 500) improves the self-supervised test accuracy and the final classification accuracy.

### Transfer Learning

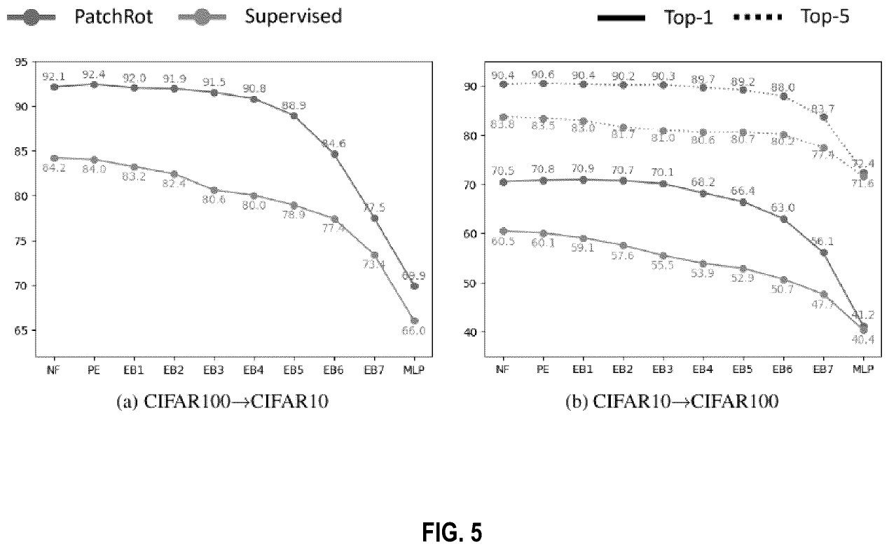

PatchRot aims to learn rich features in an unsupervised manner and in this section, we show its advantage for the transfer learning settings on CIFAR100→CIFAR10 and CIFAR10→CIFAR100 tasks. We first train the network on source data using PatchRot vs. the supervised object classification task. These networks are used as the initialization to train on the target dataset and the results are in FIG. 5. We can observe that PatchRot extracts better features than the supervised training which can be used across datasets. Also, PatchRot has a significant margin advantage over supervised training which drops only during the last few layers (where layers become domain/task-specific). Hence, pre-training the network with PatchRot has a significant advantage over supervised training.

### Application to Semi-Supervised Learning

Self-supervised learning techniques are being popularly utilized for semi-supervised learning by training the network with labeled data and simultaneously training another output head of the network with the unlabeled data using the self-supervised loss (Gidaris et al. [2018], Zhai et al. [2019]). In our experiments, instead of training the ViT on both the supervised and PatchRot loss together, we first train the network with PatchRot (self-supervised loss) on all the data and then fine-tune the network using the labeled data only (Similar to previous experiments). We use CIFAR-10 for these experiments with {40, 250, 1000, 4000, 10000, 20000, 30000 and 40000} labeled samples and the results are in Table 2. The second column (Sup) denotes the test accuracy on training the network with labeled samples only. As expected, with the increase in the number of labeled samples, training more layers is beneficial. PatchRot pre-training results in superior performance than the Supervised training showcasing its application in semi-supervised learning.

### The Case of Rotation Invariant Objects

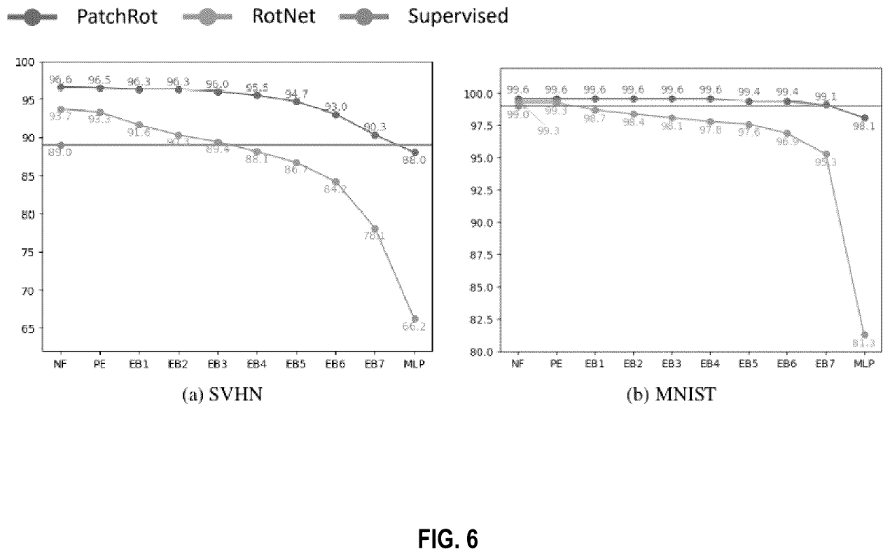

Predicting the rotation angle of an object works only if the object is distinguishable when rotated by different angles. PatchRot also performs rotation on the image patches and predicting their rotation angle still requires knowledge of the object in the image. However, some patches can be rotation invariant too but those patches are generally part of the background. Hence, PatchRot is helpful for rotation invariant objects as well. We perform this experiment on the digits datasets: SVHN and MNIST where digits like 0, 1, and 8 are rotation invariant whereas the other digits can differentiate the rotation angles. We use the same experiment setting as the other datasets and the results are shown in FIG. 6. RotNet (Gidaris et al. [2018]) provides superior performance than supervised due to some rotation discriminative digits (like 2, 3, 4, etc.) but PatchRot gets a significantly higher performance than Image-level rotation prediction and supervised training.

### Summary

In this paper, we proposed PatchRot which is an easy-to-understand and implement self-supervised technique. PatchRot trains a Vision transformer to predict rotation angles∈{0°, 90°, 180°, 270°} of image and image patches. With extensive experiments on multiple datasets, we showcased that a Vision transformer pretrained with our approach achieves superior results on downstream supervised learning. PatchRot is a robust technique that works for rotation invariant objects as well and can be applied in transfer and semi-supervised learning settings.

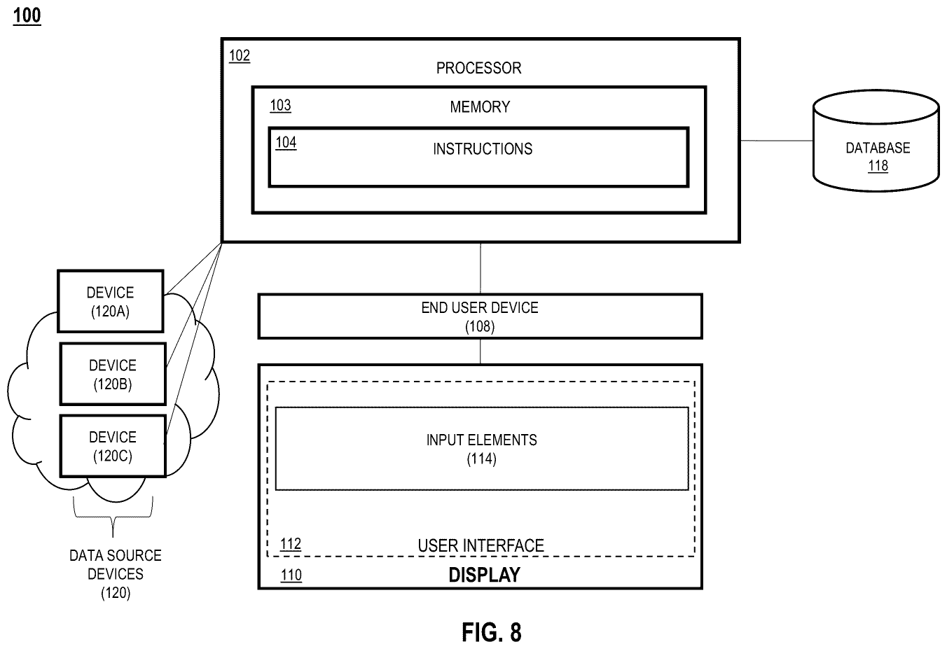

Referring to FIG. 8, embodiments of a system described herein may take the form of a computer-implemented system, designated system 100, configured for PatchRot as described herein. In general, as indicated, the system 100 includes at least one processor 102 or processing element that is configured for executing functions/operations described herein; e.g., the processor 102 can execute instructions 104 stored in a memory 103 including any form of machine-readable medium. In general, the processor 102, via instructions, accesses input data and is configured to rotate images/patches to train vision transformers, among other functions described herein.

The instructions 104 may be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, one or more of the features for processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103 and/or the memory of computing device 1200), and the processor 102 performs the tasks defined by the code. In some embodiments, the processor 102 is a processing element of a cloud such that the instructions 104 may be implemented via a cloud-based web application.

In some examples, the processor access input data from an end user device 108 in operable communication with a display 110. An end-user, via a user interface 112 rendered along the display 110, can provide input elements 114 to the processor 102 for executing functionality herein. In addition, examples of the system 100 include one or more data source devices 120 for accessing by the processor 102 datasets, images, and other input data as described herein.

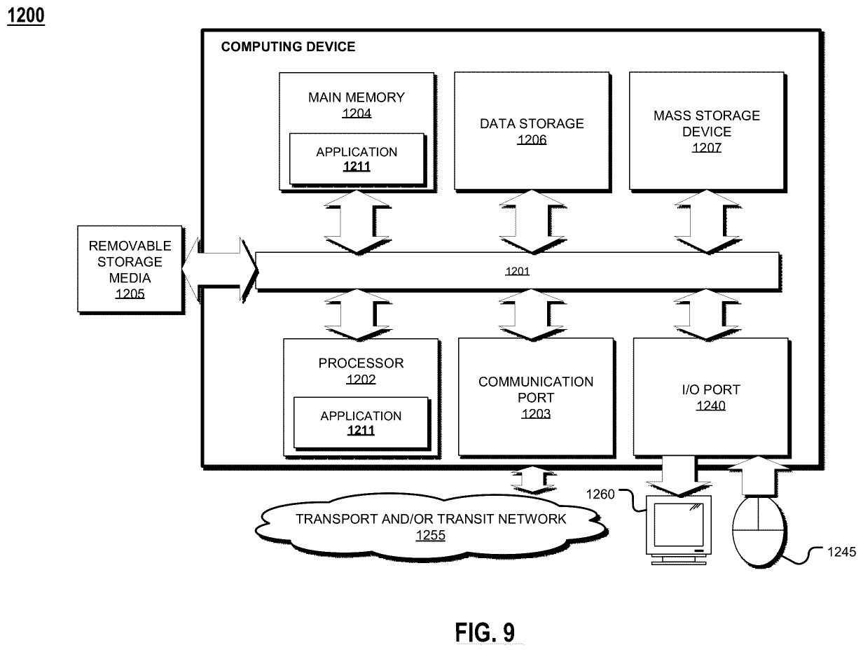

Referring to FIG. 9, a computing device 1200 is illustrated which may be configured, via the instructions 104 and/or other computer-executable instructions, to execute functionality described herein. More particularly, in some embodiments, aspects of the system and/or methods described herein may be translated to software or machine-level code, which may be installed to and/or executed by the computing device 1200 such that the computing device 1200 is configured to functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

### APPENDIX

### Tabular and Additional Results

In the main paper, we provided the comparison against RotNet and supervised training in graphs. Here, we provide the results in tabular format for easy lookup. We also experiment with training ViT using different patch sizes and compare the approach with random initialization in a similar manner. The results for these are in Table 3, 4, 5, 6, 7, 8, 9 and 10.

TABLE 3
Top-1 Classification accuracies on CIFAR-10 using patch size of 4.

| Initialization | NF | PE | EB1 | EB2 | EB3 | EB4 | EB5 | EB6 | EB7 | MLP |
|---|---|---|---|---|---|---|---|---|---|---|
| Random | 83.9 | 77.2 | 75.8 | 75.6 | 74.0 | 70.9 | 65.6 | 52.9 | 41.9 | 34.3 |
| RotNet | 88.7 | 89.1 | 87.9 | 87.0 | 85.9 | 84.2 | 83.0 | 81.4 | 78.3 | 67.6 |
| PatchRot | 92.6 | 92.5 | 92.3 | 92.4 | 91.8 | 91.1 | 90.0 | 87.0 | 83.2 | 75.8 |
| (Ours) | | | | | | | | | | |

TABLE 4
Top-1 Classification accuracies on CIFAR-10 using patch size of 8.

| Initialization | NF | PE | EB1 | EB2 | EB3 | EB4 | EB5 | EB6 | EB7 | MLP |
|---|---|---|---|---|---|---|---|---|---|---|
| Random | 79.0 | 73.6 | 72.8 | 72.2 | 71.8 | 70.2 | 65.8 | 50.7 | 39.3 | 31.8 |
| RotNet | 85.3 | 85.5 | 84.5 | 83.4 | 82.7 | 81.5 | 80.2 | 78.2 | 74.9 | 66.1 |
| Patch Rot | 87.2 | 87.0 | 86.6 | 86.2 | 84.9 | 84.3 | 83.0 | 80.2 | 77.0 | 70.0 |
| (Ours) | | | | | | | | | | |

TABLE 5
Top-1 and Top-5 Classification accuracies on CIFAR-100 using patch size of 4.

| Initialization | Metric | NF | PE | EB1 | EB2 | EB3 | EB4 | EB5 | EB6 | EB7 | MLP |
|---|---|---|---|---|---|---|---|---|---|---|---|
| Random | Top-1 | 50.2 | 45.4 | 44.3 | 43.3 | 41.9 | 40.4 | 37.7 | 25.3 | 14.8 | 10.1 |
| | Top-5 | 81.6 | 74.2 | 74.0 | 73.2 | 72.7 | 70.5 | 66.7 | 55.2 | 42.8 | 33.8 |
| RotNet | Top-1 | 62.5 | 62.3 | 60.7 | 58.6 | 56.1 | 54.7 | 53.6 | 51.5 | 46.2 | 32.3 |
| | Top-5 | 85.1 | 84.9 | 84.5 | 83.2 | 81.8 | 81.6 | 81.4 | 80.7 | 76.7 | 63.0 |
| Patch Rot | Top-1 | 70.6 | 70.7 | 70.6 | 70.4 | 69.2 | 67.4 | 64.7 | 60.8 | 53.1 | 43.1 |
| | Top-5 | 90.2 | 90.4 | 90.1 | 90.4 | 89.7 | 89.0 | 88.1 | 86.6 | 82.5 | 75.1 |

### More Attention Maps

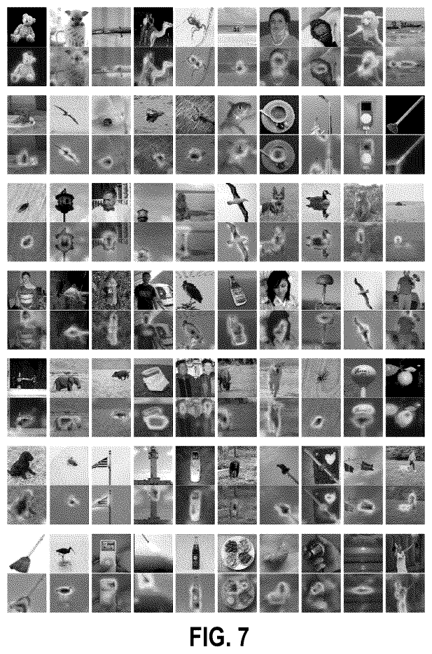

We show more attention maps on the validation set of Tiny-ImageNet dataset in FIG. 7.

TABLE 6
Top-1 and Top-5 Classification accuracies on CIFAR-100 using patch size of 8.

| Initialization | Metric | NF | PE | EB1 | EB2 | EB3 | EB4 | EB5 | EB6 | EB7 | MLP |
|---|---|---|---|---|---|---|---|---|---|---|---|
| Random | Top-1 | 50.2 | 45.4 | 44.3 | 43.3 | 41.9 | 40.4 | 37.7 | 25.3 | 14.8 | 10.1 |
| | Top-5 | 76.5 | 71.1 | 70.6 | 69.6 | 69.2 | 67.9 | 65.8 | 52.5 | 38.2 | 29.8 |
| RotNet | Top-1 | 54.1 | 53.5 | 51.6 | 50.4 | 47.9 | 47.5 | 46.2 | 45.9 | 40.6 | 29.4 |
| | Top-5 | 80.3 | 80.2 | 79.0 | 77.9 | 77.1 | 76.0 | 75.7 | 75.5 | 71.1 | 59.4 |
| PatchRot | Top-1 | 60.5 | 61.2 | 60.9 | 58.7 | 57.1 | 54.5 | 53.8 | 52.2 | 45.2 | 34.0 |
| | Top-5 | 84.9 | 85.6 | 85.1 | 84.2 | 83.3 | 82.4 | 81.6 | 81.1 | 75.6 | 66.0 |

TABLE 7
Top-1 Classification accuracies on FashionMNIST using patch size of 4.

| Initialization | NF | PE | EB1 | EB2 | EB3 | EB4 | EB5 | EB6 | EB7 | MLP |
|---|---|---|---|---|---|---|---|---|---|---|
| Random | 89.8 | 87.8 | 88.2 | 88.2 | 87.9 | 87.4 | 84.5 | 79.9 | 74.9 | 63.1 |
| RotNet | 89.9 | 89.4 | 88.5 | 88.2 | 88.0 | 87.4 | 87.1 | 87.1 | 86.2 | 77.8 |
| Patch Rot | 94.1 | 94.0 | 94.0 | 94.0 | 94.1 | 93.7 | 93.6 | 93.1 | 92.1 | 86.8 |
| (Ours) | | | | | | | | | | |

TABLE 8
Top-1 Classification accuracies on FashionMNIST using patch size of 8.

| Initialization | NF | PE | EB1 | EB2 | EB3 | EB4 | EB5 | EB6 | EB7 | MLP |
|---|---|---|---|---|---|---|---|---|---|---|
| Random | 90.7 | 76.5 | 89.6 | 89.1 | 88.9 | 88.7 | 87.9 | 85.6 | 80.9 | 71.8 |
| RotNet | 91.1 | 90.9 | 90.4 | 90.2 | 89.2 | 89.0 | 88.9 | 87.9 | 87.1 | 76.7 |
| Patch Rot | 92.0 | 92.4 | 92.7 | 92.8 | 92.6 | 92.3 | 92.4 | 91.4 | 89.8 | 85.2 |
| (Ours) | | | | | | | | | | |

TABLE 9
Top-1 and Top-5 Classification accuracies on Tiny-ImageNet using patch size of 8.

| Initialization | Metric | NF | PE | EB1 | EB2 | EB3 | EB4 | EB5 | EB6 | EB7 | MLP |
|---|---|---|---|---|---|---|---|---|---|---|---|
| Random | Top-1 | 41.9 | 36.6 | 35.4 | 33.5 | 33.2 | 31.9 | 29.4 | 18.9 | 9.9 | 6.9 |
| | Top-5 | 66.4 | 61.4 | 60.1 | 59.5 | 59.3 | 57.7 | 54.4 | 39.5 | 26.4 | 19.7 |
| RotNet | Top-1 | 45.1 | 45.2 | 43.8 | 41.0 | 38.4 | 36.9 | 36.4 | 36.3 | 30.7 | 22.2 |
| | Top-5 | 69.0 | 69.1 | 67.8 | 65.8 | 64.0 | 63.5 | 63.3 | 62.6 | 55.8 | 46.0 |
| PatchRot | Top-1 | 48.6 | 47.4 | 45.5 | 44.6 | 43.2 | 42.7 | 41.6 | 40.0 | 35.5 | 26.3 |
| | Top-5 | 73.4 | 72.2 | 71.1 | 70.7 | 69.5 | 69.5 | 68.0 | 67.2 | 62.3 | 52.5 |

TABLE 10
Top-1 and Top-5 Classification accuracies on Tiny-ImageNet using patch size of 16.

| Initialization | Metric | NF | PE | EB1 | EB2 | EB3 | EB4 | EB5 | EB6 | EB7 | MLP |
|---|---|---|---|---|---|---|---|---|---|---|---|
| Random | Top-1 | 33.9 | 29.9 | 29.5 | 28.5 | 27.7 | 27.4 | 25.8 | 15.2 | 8.3 | 5.6 |
| | Top-5 | 59.3 | 54.7 | 54.1 | 53.1 | 52.5 | 52.3 | 49.9 | 34.6 | 23.1 | 17.3 |
| RotNet | Top-1 | 35.8 | 35.6 | 33.7 | 31.5 | 30.8 | 30.2 | 29.4 | 29.6 | 27.6 | 22.2 |
| | Top-5 | 61.8 | 61.1 | 59.5 | 57.8 | 56.7 | 56.3 | 55.8 | 56.1 | 53.4 | 46.6 |
| PatchRot | Top-1 | 38.2 | 37.8 | 37.0 | 36.2 | 34.7 | 34.4 | 33.9 | 33.1 | 29.1 | 22.8 |
| | Top-5 | 65.1 | 64.7 | 63.8 | 62.9 | 61.7 | 61.5 | 60.7 | 59.6 | 56.1 | 46.8 |

It is believed that the present disclosure and many of its attendant advantages should be understood by the foregoing description, and it should be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for self-supervised training of Vision Transformers, comprising:
a processor in communication with a memory, the memory including instructions executable by the processor to:
access a plurality of input images, a parameter for a patch size, and a plurality of rotation operations for rotating an image or an image patch;
divide each image in the plurality of images into a plurality of patches of equal size based on the parameter for patch size;
generate a plurality of rotated images by iteratively:
selecting an image from the plurality of images,
selecting an image-rotation operation from the plurality of rotation operations, and
applying the image-rotation operation to the image;
generate a plurality of patch-rotated images by iteratively:
selecting an image from the plurality of images,
applying a patch-rotation operation based on the plurality of rotation operations for each patch in the plurality of patches for the image; and
train a model based on the plurality of rotated images and the plurality of patch-rotated images by iteratively:
selecting a training image from the plurality of rotated images or the plurality of patch-rotated images,
predicting the image-rotation operation applied to the training image if the training image was selected from the plurality of rotated images, and
predicting the patch-rotation operation for each patch in the plurality of patches for the training image if the training image was selected from the plurality of patch-rotated images.

2. The system of claim 1, wherein the model is trained to predict rotation angles associated with the plurality of images and respective patches of the plurality of images.

3. The system of claim 1, wherein a classification head of the model is used to predict a rotation angle of the image.

4. The system of claim 1, wherein the model as trained uses a last encoder output of other heads to predict rotation angles for individual patches using new multilayer perceptron heads.

5. A method for image processing using vision transformers configured via self-supervised training, comprising:
accessing data associated with an image; and
conducting, by a processor, an image recognition task for the image by executing a vision transformer configured to extract both global and local features from the image, wherein the vision transformer is trained to predict rotation angles by rotation of the image and patches of the image.
